(19) United States
(12) Patent Application Publication
(10) Pub. No.: US 2026/0270637 A1
(43) Pub. Date: Sep. 10, 2026

(54) A METHOD OF PROCESSING AUDIO FOR PLAYBACK OF IMMERSIVE AUDIO

(71) Applicants: Dolby Laboratories Licensing Corporation, San Francisco, CA (US); DOLBY INTERNATIONAL AB, Dublin (IE)

(72) Inventors: C. Phillip BROWN, Castro Valley, CA (US); Eytan RUBIN, Nuremberg (DE); Jacobo GIRALT, Nuremberg (DE); Michal Stanislaw RYBCZYNSKI, Wroclaw (PL); Thomas ZIEGLER, Nuremberg (DE)

(73) Assignees: Dolby Laboratories Licensing Corporation, San Francisco, CA (US); DOLBY INTERNATIONAL AB, Dublin (IE)

(21) Appl. No.: 18/721,861

(22) PCT Filed: Dec. 19, 2022
(86) PCT No.: PCT/US2022/081951

§ 371 Date: Jun. 19, 2024

Related U.S. Application Data
(60) Provisional application No. 63/291,598, filed on Dec. 20, 2021.
(60) Provisional application No. 63/353,778, filed on Jun. 20, 2022.

(30) Foreign Application Priority Data
Jun. 20, 2022 (EP) 22179943.0

(51) Int. Cl. H04S 7/00; H04R 5/02; H04S 3/00

(52) U.S. Cl. CPC H04S 7/302; H04R 5/02; H04S 3/008; H04S 7/305; H04S 7/307; H04R 2499/13; H04S 2400/01; H04S 2400/11; H04S 2400/13

(57) ABSTRACT

A method (1000) of generating at least two audio channels from audio in an immersive audio format comprising at least one height audio channel (1010) and at least two non-height audio channels (1050, 1100), for playing back the at least two audio channels with a non-immersive loudspeaker system of at least two audio loudspeakers (1,2) inside a vehicle. The method comprises applying (1500) a virtual height filter (1300) to the height channel (1010) for, when playing back the height channel by one of the loudspeakers, attenuating spectral components of the height channel directly emanating from said loudspeaker (1;2) and for amplifying spectral components of the height channel reflected from a roof or an area close to the roof inside the vehicle, to generate a virtual height filtered audio signal (1175) and mixing (1700) the virtual height filtered audio signal with at least one of the two non-height audio channels.

### CROSS-REFERENCE TO RELATED APPLICATION

This application claims priority of the following priority application: U.S. provisional application 63/291,598 (reference: D21147AUSP1), filed 20 Dec. 2021, U.S. provisional application 63/353,778 (reference: D21147AUSP2), filed 20 Jun. 2022 and EP application EP22179943.0 (reference: D21147AEP), filed 20 Jun. 2022.

### TECHNICAL FIELD

This disclosure relates to the field of audio processing. In particular, the disclosure relates to a method of generating at least two audio channels from audio in an immersive audio format for playback the at least two audio channels with a (non-immersive) loudspeaker system. The disclosure further relates to an apparatus comprising a processor configured to carry out the method, to a vehicle comprising the apparatus, to a program and a computer-readable storage medium.

### BACKGROUND

Vehicles usually contain loudspeaker systems for audio playback. Loudspeaker systems in vehicles may be used to playback audio from, for example, tapes, CDs, audio streaming services or applications executed in an automotive entertainment system of the vehicle or remotely via a device connected to the vehicle. The device may be, e.g., a portable device connected to the vehicle wirelessly or with a cable. For example, most recently, streaming services such as Spotify and Tidal have been integrated into the automotive entertainment system, either directly in the vehicle's hardware (usually known as the “head unit”) or via a smart phone using Bluetooth or Apple CarPlay or Android Auto. The loudspeaker systems in vehicles may also be used to playback terrestrial and/or satellite radio. Conventional loudspeaker systems for vehicles are stereo loudspeakers systems. Stereo loudspeaker systems may include a total of four loudspeakers: a front pair of loudspeakers and a rear pair of loudspeakers, for the front and rear passengers, respectively. However, in more recent years, with the introduction of DVD players in vehicles, surround loudspeaker systems have been introduced in vehicles to support playback of DVD audio format. FIG. 1 shows an interior view of a vehicle 100. Vehicle 100 includes a surround loudspeaker system including loudspeakers 10, 11, 30, 31, 41, 42 and 43. The loudspeakers are only shown for the left side of vehicle 100. Corresponding loudspeakers may be arranged symmetrically on the right side of vehicle 100. In particular, the surround loudspeaker system of FIG. 1 includes: pairs of tweeter loudspeakers 41, 42 and 43, a pair of full range front loudspeaker 30 and rear loudspeaker 31, a central loudspeaker 10 and a Low Frequency Effects loudspeaker or Subwoofer 11. Tweeter loudspeaker 41 is placed close to the dashboard of the vehicle. Tweeter loudspeaker 42 is placed low on a front side pillar of vehicle 100. However, tweeter loudspeakers 41, 42, 43 but also full range front and rear loudspeakers 30 and 31 may be placed in any position suitable for the specific implementation.

Immersive audio is becoming mainstream in cinemas and homes listening environments. With immersive audio becoming mainstream in the cinema and the home, it is natural to assume that immersive audio will be played back also inside vehicles. Dolby Atmos Music is already available via various streaming services. Immersive audio is often differentiated from surround audio format by the inclusion of an overhead or height audio channel. Therefore, for playing back immersive audio, overhead or height loudspeakers are used. While high end vehicles may contain such overhead or height loudspeakers, most of the conventional vehicles still use a stereo loudspeaker system or a more advanced surround loudspeaker system as shown in FIG. 1. In fact, height loudspeakers dramatically increase complexity of the loudspeaker system in the vehicles. The height loudspeaker needs to be placed in the roof of the vehicle which is usually not adapted for this purpose. For example, vehicles have usually a low roof which limits the available height for placement of height loudspeaker. Furthermore, vehicles are often sold with the option to mount a sunroof to uncover a window in the vehicle's roof, making a difficult industrial design challenge to integrate or place height loudspeakers in the roof. Additional audio cables may also be required for such height loudspeakers. For all these reasons, integration of height loudspeakers in vehicles may be costly due to space and industrial design constraints.

### SUMMARY

It would be advantageous to playback immersive audio content in a non-immersive loudspeaker system, for example a stereo loudspeaker system or a surround loudspeaker system. In the context of the present disclosure a “non-immersive loudspeaker system” is a loudspeaker/speaker system that comprises at least two loudspeakers but no (i.e. without) overhead loudspeakers (i.e. no height speakers).

It would be advantageous to create a perception of sound height by playing back immersive audio content into non-immersive loudspeaker systems such that the user's audio experience is enhanced even without the use of overhead loudspeakers.

An aspect of this disclosure provides a method of generating at least two audio channels from audio in an immersive audio format comprising at least one height audio channel and at least two non-height audio channels, for playing back the at least two audio channels with a non-immersive loudspeaker system of at least two audio loudspeakers inside a vehicle (or inside any listening environment). The method comprises applying a virtual height filter to the at least one height channel. The virtual height filter is configured for, when the at least one audio height channel is played back by one of the at least two loudspeakers, at least partially attenuating spectral components of the at least one height channel directly emanating from the loudspeaker from which the height channel is played back. The virtual height filter is also configured for at least partially amplifying spectral components of the at least one height channel reflected from a roof or an area close to the roof inside the vehicle, to generate at least one virtual height filtered audio signal. The method further comprises mixing the at least one virtual height filtered audio signal with at least one of the two non-height audio channels to generate the at least two audio channels.

In the context of the present disclosure the term “channel” means an audio signal plus optionally metadata in which the position is coded as a channel identifier, e.g., left-front or right-top surround; “channel-based audio” is audio formatted for playback through a pre-defined set of loudspeaker zones with associated nominal locations, e.g., 5.1, 7.1, and so on; the term “object” or “object-based audio” means one or more audio channels with a parametric source description, such as apparent source position (e.g., 3D coordinates), apparent source width, etc.

When the height channel is played back from one of the at least two loudspeakers without filtering, sound may radiate along different paths. Some sound may radiate along a direct path from the loudspeaker to a listening position (e.g., to a passenger's or driver's ears). Some other sound may radiate along a reflected path from the loudspeaker to the listening position. For example, some sound may be reflected from the roof or area close to the roof inside the vehicle and therefore radiate from the roof or area close to the roof, to the listening position. The sound that radiates along the direct path is undesired when the height channel is played back. By applying the virtual height filter to the at least one height channel, the spectral components of the height channel reflected from the roof or the close to the roof are amplified while the spectral components of the height channel directly emanated to the loudspeaker are attenuated. Configured as above the method compensates for the undesired direct sound and introduces perceptual height cues into the audio signal being fed to one of the at least two loudspeakers, thereby improving the positioning and perceived quality of the virtual height signal. For example, a directional hearing model has been developed to create a virtual height filter, which when used to process audio being reproduced by the at least two loudspeakers, improves that perceived quality of the reproduction.

In an embodiment, the audio in the immersive audio format may further comprise at least two further non-height audio channels. The virtual height filtered audio signal may be mixed with each one of the non-height audio channels to generate four audio channels.

In an embodiment, the audio in the immersive audio format may comprise at least two height audio channels. The virtual height filter may be applied to each one of the at least two height audio channels to generate at least two virtual height filtered audio signals. Each one of the virtual height filtered audio signals may be mixed with one of the at least two non-height channels.

In an embodiment, the audio in the immersive audio format may comprise four height audio channels and four non-height audio channels. The virtual height filter may be applied to each one of the four height audio channels to generate four virtual height filtered audio signals. Each one of the virtual height filtered audio signals may be mixed with one of the four non-height channels.

In an embodiment, the virtual height filter may have a filter transfer function and wherein the method further comprises determining the filter transfer function of the virtual height filter from one or more parameters identifying the filter transfer function.

In an embodiment, the method may further comprise storing the one or more parameters in a processor as a look-up table or as an analytical function.

In an embodiment, the virtual height filter may have a filter transfer function having a peak at a first frequency and a notch at a second frequency higher than the first frequency.

In an embodiment, the at least two audio loudspeakers may be laterally spaced with respect to a listening position and the method may further comprise determining a filter transfer function for the virtual height filter based on a relative distance of the at the least two loudspeakers from the listening position and on an elevation of the roof or area close to the roof relative to the listening position.

In an embodiment, the at least two audio loudspeakers may be laterally spaced with respect to a listening position and the method may further comprise obtaining a plurality of filter transfer functions for a plurality of virtual height filters based on a range of relative distances of the at the least two loudspeakers from the listening position and on a range of elevations of the roof or area close to the roof relative to the listening position; and selecting one filter transfer function from the plurality of filter transfer functions.

In an embodiment, the selected filter transfer function may be the average of the plurality of filter transfer functions.

In an embodiment, selecting one filter transfer function from the plurality of filter transfer functions may comprise selecting one or more parameters identifying the selected filter transfer function based on an average distance of the at the least two loudspeakers from the listening position and based on an average elevation of the roof or area close to the roof relative to the listening position.

In an embodiment, the steps of obtaining, selecting, applying and mixing of the method described above may be iteratively applied for each selected filter transfer function until the filter transfer function provides a playback of the at least two channels with maximum perception of sound elevation.

In an embodiment, the method may further comprise applying a gain to the virtual height filter. In an embodiment, the gain may be user configurable. Another aspect of this disclosure provides an apparatus comprising a processor and a memory coupled to the processor, wherein the processor is configured to carry out any of methods described in the present disclosure.

Another aspect of this disclosure provides a vehicle comprising such apparatus.

Other aspects of the present disclosure provide a program comprising instructions that, when executed by a processor, cause the processor to carry out the method of processing audio and further a computer-readable storage medium storing such program.

### BRIEF DESCRIPTION OF THE DRAWINGS

Embodiments of the present disclosure are illustrated by way of example, and not by way of limitation, in the accompanying drawings, wherein like reference numerals refer to similar elements, and in which:

FIG. 1 schematically shows an interior view of a vehicle with a loudspeaker system arranged according to an embodiment of the disclosure,

FIG. 2 is a flowchart illustrating an example of a method of generating at least two audio channels from audio in an immersive audio format according to an embodiment of the disclosure,

FIG. 2A schematically shows an example of a method of generating at least two audio channels from audio in an immersive audio format according to an embodiment of the disclosure,

FIG. 3 schematically shows a vehicle,

FIG. 4 schematically shows a top view of a vehicle with a loudspeaker system arranged according to an embodiment of the disclosure,

FIG. 5 schematically shows exemplary paths of sound inside a vehicle,

FIG. 6 schematically shows some examples of a virtual height filter according to some embodiments of the present disclosure,

FIG. 7 schematically shows an example of a method of generating four audio channels from audio in an immersive audio format according to an embodiment of the disclosure,

FIG. 8 schematically shows an example of a method of generating two audio channels from audio in an immersive audio format according to an embodiment of the disclosure,

FIG. 9 schematically shows an example of a method of generating four audio channels from audio in an immersive audio format according to an embodiment of the disclosure,

FIG. 10 schematically shows an example of a method of generating six audio channels from audio in an immersive audio format according to an embodiment of the disclosure,

FIG. 10A schematically shows an example of a method of generating eight audio channels from audio in an immersive audio format according to an embodiment of the disclosure,

FIG. 11 is a schematic illustration of an example of an apparatus for carrying out methods according to embodiments of the disclosure.

### DETAILED DESCRIPTION

Numerous specific details are described below to provide a thorough understanding of the present disclosure. However, the present disclosure may be practiced without these specific details. In addition, well-known parts may be described in less exhaustive detail. The figures are schematic and comprise parts relevant for understanding the present disclosure, whereas other parts may be omitted or merely suggested.

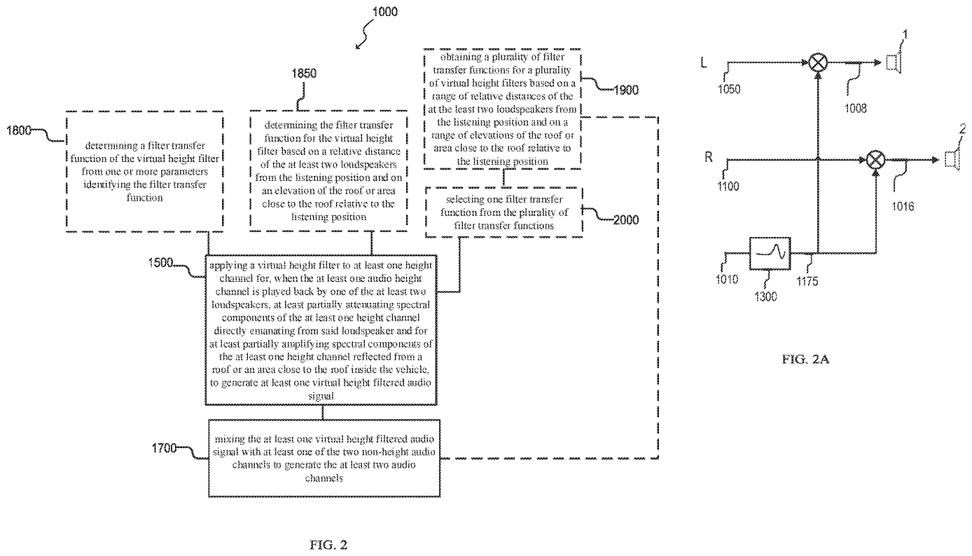

FIG. 2 shows a flowchart illustrating an example of a method 1000 of generating at least two audio channels from audio in an immersive audio format according to an embodiment of the disclosure. The audio in the immersive audio format comprises at least one height channel and at least two non-height channels. Method 1000 can be used to playback the generated at least two audio channels with a non-immersive loudspeaker system of at least two audio loudspeakers inside a vehicle. The vehicle may be any type of passenger or non-passenger vehicle, e.g. used for commercial purposes or to transport cargo. Examples provided in this disclosure assume that playback of the generated at least two audio channels is performed inside a vehicle. However, the generated at least two audio channels may be played back inside any other type of listening environment suitable for the specific implementation, e.g., closed or partially closed listening environment, e.g., a room.

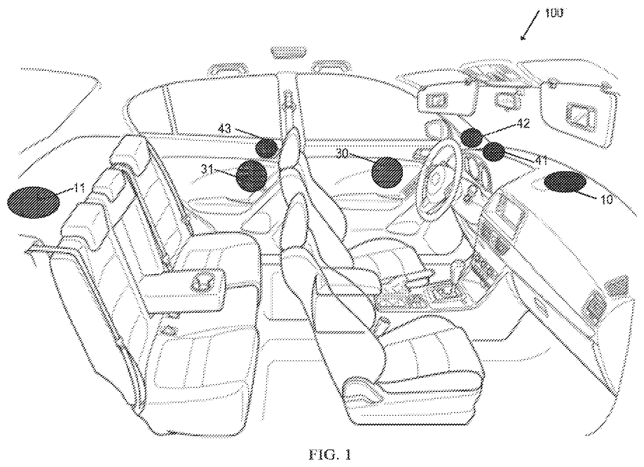

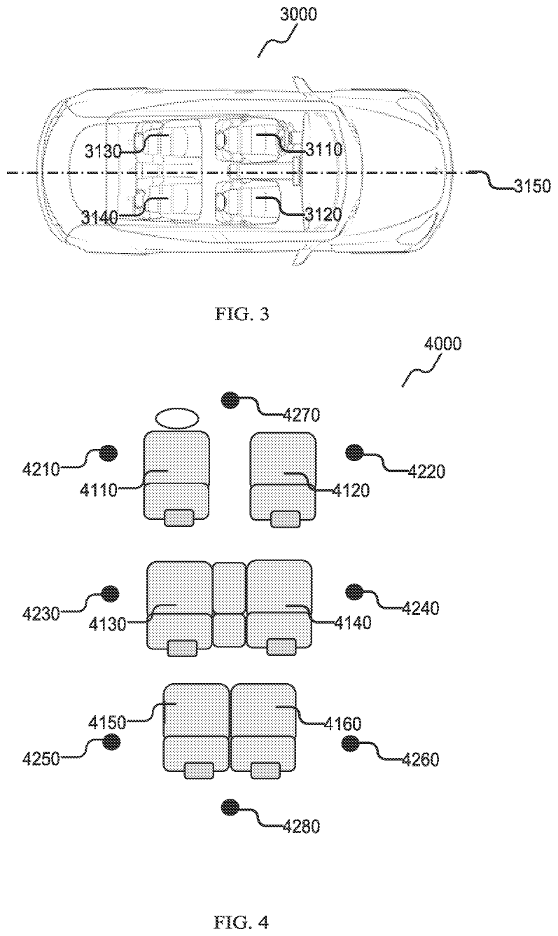

For example, with reference to FIG. 3, vehicle 3000, in this example a four-passenger car, is schematically drawn. For simplicity, arrangement of the loudspeakers is not shown in FIG. 3, but it is shown in the more detailed interior view of vehicle 100 of FIG. 1. Passenger car 3000 has four seats 3110, 3120, 3130 and 3140. When considering the loudspeaker system shown in FIG. 1, loudspeakers 30, 31, 41, 42, 43 will have corresponding loudspeakers (not shown in the Figures) arranged at the right-hand side of vehicle 3000. With reference to FIG. 3, the loudspeakers at the left-hand side of vehicle 3000 and their respective counterparts at the right-hand side of vehicle 3000 are arranged reflective symmetrically with respect to a center axis 3150, crossing the center of vehicle 3000 along its length. It will be appreciated that each of seats 3110, 3120, 3130 and 3140 and thus, the potential listeners located thereof, may be symmetrically off center with respect to any pair of loudspeakers comprising loudspeakers 30, 31, 41, 42, 43 (not shown in FIG. 3) and their respective counterparts at the right-hand side of vehicle (also not shown in FIG. 3). For example, a driver seating at driver seat 3110 will be symmetrically off center between loudspeakers 30, 41, 42 and the corresponding right-hand side loudspeakers (not shown in the Figures). The driver will be closer to loudspeakers 30, 41 and 42 than to the corresponding loudspeakers at the right-hand side of vehicle 3000. In FIG. 1 and FIG. 3, the driver's seat is shown at the left side (left with respect to a forward direction of driving) of vehicle 3000. However, it is understood that location of the driver's seat in a vehicle can be different in different regions. For example, in UK, Australia or Japan, the driver's seat is located on a right side of the vehicle with respect to the forward direction of driving the vehicle.

The non-immersive loudspeaker system may be for example a stereo loudspeaker system or a surround loudspeaker system as shown with reference to FIG. 1.

In an embodiment the audio in the immersive audio format may be audio rendered in the immersive audio format.

The immersive audio format of (e.g. rendered) audio may comprise at least one height channel. In an embodiment, the immersive audio format may be an object-based audio format supporting elevation, e.g. a Dolby Atmos format. In another embodiment, the immersive audio format may be channel-based audio format supporting elevation, e.g. a X.Y.Z audio format, where X≥2 is the number of front or surround audio channels, Y≥0 is, when present, a Low Frequency Effects or subwoofer audio channel, and Z≥1 is the at least one height audio channel. In an embodiment, the object-based audio format (e.g., supporting elevation) may be rendered or pre-rendered to a corresponding channel-based audio format for generating loudspeaker feeds corresponding to the channels of the channel-based audio format. Loudspeaker system shown in FIG. 1 is a typical 5.1 loudspeaker system for playback of 5.1 audio with 5 front or surround loudspeakers, two left audio loudspeakers (e.g. left and left surround), two right audio loudspeakers (e.g. right and right surround), a center loudspeaker and one LFE loudspeaker. The two left audio loudspeakers correspond to loudspeakers 30, 31 (for mid-range or full range frequency), 41, 42 and 43 (for high-range frequency). The center loudspeaker corresponds to loudspeaker 10. The LFE loudspeaker corresponds to loudspeaker 11.

For example, with reference to FIG. 4, a top view of another exemplary vehicle 4000 is schematically shown. Vehicle 4000 may be a six or seven-passengers vehicle distributed in three different rows. Vehicle 4000 may be, for example, a Sport Utility Vehicle (SUV) or mini-bus. Vehicle 4000 has six seats 4110, 4120, 4130, 4140, 4150 and 4160. For vehicle 4000, a typical 7.1 loudspeaker system may be implemented. Loudspeaker system shown in FIG. 4 has three left loudspeakers 4210, 4230 and 4250 (e.g., left and two left surrounds) and three right loudspeakers 4220, 4240 and 4260 (e.g., right and two right surrounds), a center loudspeaker 4270 and a LFE loudspeaker 4280.

The method schematically illustrated in FIG. 2 will be explained also with reference to FIG. 2A

With reference to FIG. 2A, the audio in the immersive audio format may include non-height channels 1050 and 1100 (e.g., left and right channels) and a (single in this example) height channel 1010. The loudspeaker system of the example of FIG. 2A is a stereo loudspeaker system of loudspeakers 1 and 2. In this example, loudspeakers 1 and 2 are used for playback of audio in immersive audio format of channels 1050, 1100 and 1010. The method 1000 generates two channels 1008 and 1016 from the audio in the immersive audio format as explained herein below. Since two channels 1008 and 1016 are generated from the three channels of the immersive audio format, it can be said that the three channels of the immersive audio format are downmixed in the two channels for playback.

With reference to FIGS. 2 and 2A, method 1000 comprises applying 1500 a virtual height filter 1300 to height channel 1010. Virtual height filter 1300 is configured to at least partially attenuate spectral components of height channel 1010 which are directly emanating from one of the loudspeakers 1 or 2, when the height channel 1010 is played back by one of such loudspeakers 1 or 2. Virtual height filter 1300 is further configured to at least partially amplify spectral components of height channel 1010 reflected from a roof or an area close to the roof inside the vehicle, to generate virtual height filtered audio signal 1175. Method 1000 further comprises mixing 1700 virtual height filtered audio signal 1175 with non-height audio channels 1050 and 1100 to generate two audio channels 1008 and 1016 for playback them at loudspeakers 1 and 2. FIG. 2A shows that virtual height filtered audio signal 1175 is mixed with both non-height channel 1050 and 1100. However, virtual height filtered audio signal 1175 may be mixed with only one of non-height channels 1050 and 1100. Mixing virtual height filtered audio signal 1175 with only one non-height channel 1050 or 1100 to generate the two channels for playback, suffices to create perception of sound height or elevation without the use of height/overhead loudspeakers.

To explain further, reference is made to FIG. 5, which schematically shows exemplary paths 5300 and 5400 that sound played back by a loudspeaker 5000 may travel from loudspeaker 5000 to a listening position 5100 inside a vehicle. Loudspeaker 5000 may be any of the loudspeakers shown with reference to, e.g., loudspeaker systems of FIG. 1 and FIG. 4. In particular, loudspeaker 5000 may be any of the left, right loudspeakers or surround loudspeakers shown therein. Preferably, since height cues are typically more prevalent in high frequency signals rather than low frequency signals, loudspeaker 5000 may be any high frequency loudspeaker associated with any of the left, right or surround loudspeakers, such as, for example, speakers (e.g. tweeters) 41, 42 and 43 shown in FIG. 1. Listening position 5100 may be at the ears/head of the passenger or driver of the vehicle. Sound played back by loudspeaker 5000 may radiate along a reflected path 5300, indicated by a dashed line in FIG. 5, and along a direct path 5400, indicated by a solid line in FIG. 5. Reflected path 5300 is an indirect path from loudspeaker 5000 to listening position 5100 and is formed by the sound being reflected from a surface 5500 located above listening position 5100. Inside a vehicle, surface 5500 may be the roof of the vehicle or an area close to the roof of the vehicle. The area close to the roof may be the upper inner parts of the front windshield or rear windshield or the upper inner parts of the lateral windows of the vehicle. In general, surface 5500 may be any part of the interior of the vehicle which is, during sound playback, located at a higher elevation than (e.g. above) the listening position. For an increased perception of sound elevation, it is desirable that the sound radiates along reflected path 5300. However, some sound from loudspeaker 5000 will travel along direct path 5400, diminishing the perception of sound coming from a position at surface 5500 in which sound is reflected off to listening position 5100. The amount of this undesired direct sound in comparison to the desired reflected sound may be a function of a directivity pattern of loudspeaker 5000. It has been found that loudspeakers located at approximately half the whole height of the interior of the vehicle (e.g., approximately at the door middle height) provide for an enhanced perception of sound elevation.

To compensate for the undesired direct sound, it has been shown that incorporating signal processing to introduce perceptual height cues into the audio signal being fed to loudspeaker 5000 improves the positioning and perceived quality of the virtual height signal. For example, a directional hearing model has been developed to create a virtual height filter, which when used to process audio being reproduced by a loudspeaker, improves that perceived quality of the reproduction. In an embodiment, the virtual height filter is derived from both a physical loudspeaker location and a virtual loudspeaker location (above the listening position) with respect to the listening position. For the physical loudspeaker location, a first directional filter is determined based on a model of sound travelling directly from the loudspeaker location to the ears of a listener at the listening position. Such a filter may be derived from a model of directional hearing such as a database of HRTF (head related transfer function) measurements or a parametric binaural hearing model, pinna model, or other similar transfer function model that utilizes cues that help perceive height. Although a model that takes into account pinna models is generally useful as it helps define how height is perceived, the filter function is not intended to isolate pinna effects, but rather to process a ratio of sound levels from one direction to another direction, and the pinna model is an example of one such model of a binaural hearing model that may be used, though others may be used as well.

An inverse of this filter is next determined and used to remove the directional cues for audio travelling along a path directly from the physical loudspeaker location to the listening position. Next, for the virtual loudspeaker location, a second directional filter is determined based on a model of sound travelling directly from the virtual loudspeaker location to the ears of a listener at the same listening position using the same model of directional hearing. This filter is applied directly, imparting the directional cues the ear would receive if the sound were emanating from the virtual loudspeaker location above the listening position. In practice, the first directional filter and the second directional filter may be combined in a way that allows for a single filter that both at least partially removes (attenuates) the directional cues from the physical loudspeaker location, and at least partially inserts (amplify) the directional cues from the virtual loudspeaker location. Such a single filter provides a frequency response curve that is referred to herein as a “height filter transfer function,” “virtual height filter response curve,” “desired frequency transfer function,” “height cue response curve,” or similar words to describe a filter or filter response curve that filters, e.g., attenuate, direct sound components from height sound components in an audio loudspeaker system.

With regard to the filter model, if P1 represents the frequency response in dB of the first filter modeling sound transmission from the physical loudspeaker location and P2 represents the frequency response in dB of the second filter modeling sound transmission from the virtual loudspeaker location, then the total response of the virtual height filter PT in dB can be expressed as: PT=α(P2−P1), where a is a scaling factor or gain that controls the strength of the filter. With α=1, the filter is applied maximally, and with α=0, the filter does nothing (0 dB response). In practice, a may be set somewhere between 0 and 1 (e.g. α=0.5) based on the relative balance of reflected to direct sound. As the level of the direct sound increases in comparison to the reflected sound, so should a in order to more fully impart the directional cues of the virtual loudspeaker location to this undesired direct sound path. However, a should not be made so large as to damage the perceived timbre of audio travelling along the reflected path, which already contains the proper directional cues. In general, the exact values of the filters P1 and P2 will be a function of the azimuth of the physical loudspeaker location with respect to the listening position and the elevation of the reflected speaker location. This elevation is in turn a function of the distance of the physical loudspeaker location from the listening position and the difference between the height of the roof or area close to the roof (surface 5500 in FIG. 5) and the height of the speaker.

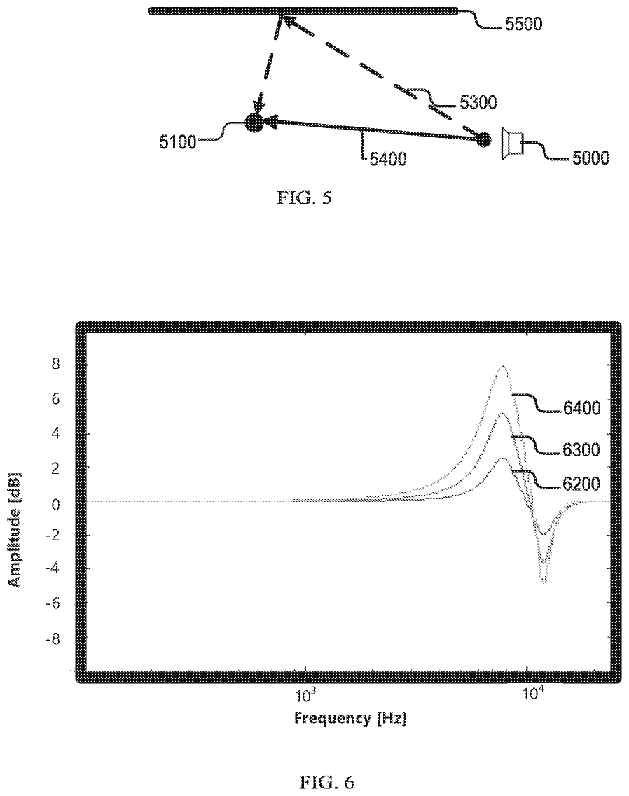

FIG. 6 shows example curves 6200, 6300 and 6400 of a virtual height filter according to some embodiments of the present disclosure. Curves 6200, 6300 and 6400 are represented in a diagram showing, in the ordinate, the amplitude of the virtual height filter, in Decibels (dB), versus, in the abscissa, the frequency, in Hertz (Hz).

Curves 6200, 6300 and 6400 represent filter transfer functions for three different virtual height filters. FIG. 6 shows that filter transfer functions 6200, 6300 and 6400 of the three different filters have a peak at a first frequency of about 8000 Hertz and a notch at a second frequency higher than the first frequency of about 12000 Hertz. However, the peak and the notch may be at different frequencies. The three different transfer functions may be obtained by applying a different scaling factor/different gain to a virtual height filter, as explained above. In an embodiment, the gains may be user-configurable such that the ‘strength’ of the virtual height filter can be tuned by the user according to the specific implementation.

In an embodiment, as shown with reference to FIG. 2, the method of the present disclosure may further comprise determining 1800 the filter transfer function of the virtual height filter from one or more parameters identifying the filter transfer function. For example, the one or more parameters may be indicative of at least one value of the peak, the frequency of the peak, the notch and the frequency of the notch of the filter transfer function representing the virtual height filter. For example, the parameters may be stored in a memory or processor containing a memory, e.g., as a look-up table or analytical function. These parameters may be retrieved by a processing unit from the memory which may reconstruct the virtual height filter therefrom. The reconstructed virtual height filter may be thus used and applied to the height channel. By using one or more parameters to identify the filter transfer function, processing of the height channels is simplified as the virtual height filter is described by a few parameters instead of being generated locally.

In an embodiment, as shown with reference to FIG. 2, the method of the present disclosure may further comprise determining 1850 the filter transfer function for the virtual height filter based on a relative distance of the at the least two loudspeakers from the listening position and on an elevation of the roof or area close to the roof relative to the listening position.

For example, in one embodiment, one or more sensors may be located at or close to the listening positions to measure such relative distance of the at the least two loudspeakers from the listening position and the elevation of the roof or area close to the roof, relative to the listening position. For example, in an embodiment, such sensors may be embedded in the head rest of each seat of the vehicle approximatively at the same height of the listener's head. Said measurements may be performed at an initial calibration stage of the method or, alternatively, substantially real-time with playback of the audio.

Alternatively, additionally or optionally the filter transfer function of the virtual height filter may be based on predetermined absolute distances between the one or more listening positions and each of the at least two loudspeakers and predetermined elevation of the roof relative to the listening position. For example, distances between the one or more listening positions (for example any of the positions at seats 3110, 3120, 3130 or 3140 of FIG. 3) and the pair of stereo loudspeakers as well as the elevation of the roof may be determined/predetermined by the environment characteristics, e.g. the vehicle's interior design, and loudspeaker installation. The method of this disclosure may use this predetermined information for obtaining the filter transfer function of the virtual height filter. For example, in an embodiment, the step of determining 1800 the filter transfer function of the virtual height filter from one or more parameters may involve accessing predetermined parameters. For example, the parameters may have been obtained/measured for one vehicle of a certain type, and subsequently stored in the memory of an on-board computing system of vehicles of the same type. Such offline calibration has the advantage that vehicles do not need to be equipped with sensors for measuring and obtaining the filter transfer function online.

Alternatively, additionally or optionally, in an embodiment as shown with reference to FIG. 2, method 1000 may further comprise, typically prior step 1500, obtaining 1900 a plurality of filter transfer functions for a plurality of virtual height filters. The plurality of virtual height filters may be obtained based on a range of relative distances of the least two loudspeakers from the listening position and on a range of elevations of the roof or area close to the roof relative to the listening position. For example, the range of distances loudspeakers-listening position(s) may be measured, e.g. during a calibration phase, for a plurality of different listening positions and/or a plurality of loudspeaker locations. Similarly, the range of elevations of the roof (or the virtual loudspeaker location thereof) may be measured, e.g. during a calibration phase, for a plurality of different listening positions. The method further comprises selecting 2000 one filter transfer function from the plurality of filter transfer functions. For example, in an embodiment, the selected filter transfer function may be based on an average distance of the at the least two loudspeakers from the listening position and based on an average elevation of the roof or area close to the roof (or of the virtual loudspeaker location) relative to the listening position. In another embodiment, the selected (filter transfer function of the) virtual height filter is the average of the plurality of filter transfer functions. For example, the selected transfer function may be determined by interpolating among the plurality of filter transfer functions. In yet another embodiment, method 1000, including steps 1900 and 2000 may be, e.g., during a calibration phase and as indicated in FIG. 2 by dashed line connecting step 1700 to step 1900, iteratively applied for each filter transfer function selected at each iteration until the selected filter transfer function provides optimal (e.g., maximize the) perception of sound elevation at the one or more listening positions. In other words, method 1000, including steps 1900 and 2000 may be iteratively applied until the (selected) filter transfer function provides a playback of the at least two channels with maximum perception of sound elevation. In general, for a simple and more effective audio processing in a specific type of vehicle, a single filter transfer function that on average performs well for most of listening positions/loudspeaker locations and elevations of the roof or area close to the roof (or elevations of the virtual loudspeaker location) may be selected. However, the filter transfer function may be adaptively determined substantially real time, e.g., by means of sensors as explained above. Adaptively determining the filter transfer function may provide a more accurate determination and therefore an enhanced perception of sound elevation.

In an embodiment, still with reference to FIG. 2, each filter transfer function of the plurality of transfer functions as obtained in step 1900 may be determined from one or more parameters, e.g. stored in a memory, as LUT or analytical function, as explained above. The method may actively/adaptively select the parameters of the filter transfer function for the specific vehicle type or when sensors are used.

In an embodiment, still with reference to FIG. 2, the step of determining 1800 the filter transfer function of the virtual height filter from one or more parameters (either based on predetermined distance/elevation information or based on actual measurements) may be triggered upon detection of a movement of a listener located at the one or more listening positions. For example, one or more sensors may be employed to detect the movement of the listener. When employed in the interior of a vehicle, such sensors may be, e.g., located at respective seats of the vehicle. Said one or more sensors may be configured to detect the presence of a passenger or driver in a vehicle and thus enabling use of the correct distance information to be used by the processing method to obtain the filter transfer function.

In an embodiment, said one or more seat sensors or a different set of sensors may be used to detect a new listening position, e.g., a new location of the listener's head (or location of the listener's hears). For example, the driver or passenger may adjust his own seat horizontally and/or vertically for a more comfortable seating position in the vehicle. In this embodiment, the method may retrieve/obtain (the filter transfer function of) the virtual height filter according to the new detected listening position. In this way the correct information, either based on a correct set of predetermined listener to loudspeakers distance information and set of predetermined roof elevation information, or based on actual measurements, may be used according to the new listening position. For example, if/when the predetermined one or more parameters identifying (the filter transfer function of) the virtual height filter are stored as an analytical function or a look up table (LUT), a different analytical function or a different LUT may correspond to a different (e.g. detected) seat or listening position.

As explained above, the immersive audio format may be of different type and suitable for the specific implementation

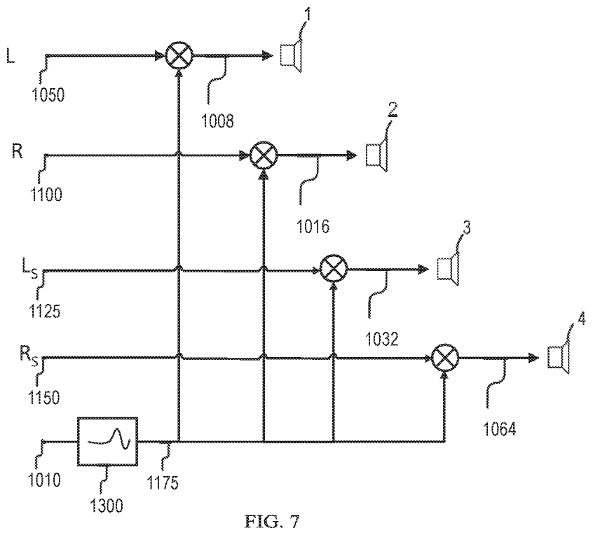

For example, with reference to FIG. 7, the immersive audio format of the audio comprises a single height channel 1010 and four non-height channels 1050, 1100, 1125 and 1150. Non-height channels 1050 and 1100 may be Left (L) and Right (R) channels, respectively. Non-height channels 1125 and 1150 may be Left surround (Ls) and Right Surround (Rs) channels, respectively. Non-height channels 1050 and 1100 may be Front, Middle or Rear Left and Right channels, respectively. Similarly, non-height channels 1125 and 1150 may be Front, Middle or Rear Left Surround and Right Surround channels, respectively.

Virtual height filter 1300 is applied to height channel 1010 to generate virtual height filtered signal 1175. Virtual height filtered signal 1175 is mixed with each one of non-height channels 1050, 1100, 1125 and 1150 to generate four channel signals 1008, 1016, 1032 and 1064. Channel signals 1008, 1016, 1032 and 1064 are fed to loudspeakers 1, 2, 3, and 4 for playback. Using a single (filter transfer function of the) virtual height filter simplifies conversion of the audio in the immersive audio format into channel feed signals 1008-1064 for loudspeakers 1-4.

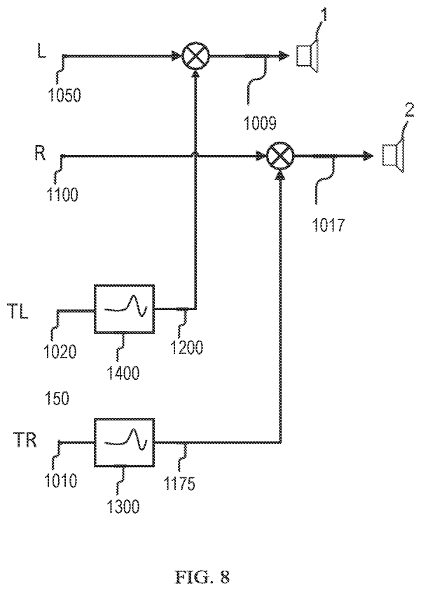

In another example, with reference to FIG. 8, the immersive audio format of the audio comprises two height channels 1010 and 1020 and two non-height channels 1050 and 1100. For example, height channels 1020 and 1010 may be Top Left (TL) and Top Right (TL) channels. Non-height channels 1050 and 1100 may be Left (L) and Right (R) channels, respectively. Channels 1020 and 1010 may be Top Front Left, Top Middle/Center Left or Top Rear Left and Right channels, respectively. Similarly, channels 1050 and 1100 may be Front Left, Middle/Center Left or Rear Left and Right channels, respectively.

Virtual height filter 1300 is applied to height channel 1010 to generate virtual height filtered signal 1175. Virtual height filter 1400 is applied to height channel 1020 to generate virtual height filtered signal 1200. Virtual height filter 1300 may be the same to virtual height filter 1400. Using a single height filter for all height channels, simplifies audio processing and require less processing power. However, in some embodiments, virtual height filter 1300 may be different from virtual height filter 1400. For example, virtual height filter 1300 may be optimized for the right channel. For example, the filter transfer function of virtual height filter 1300 may be selected for maximizing perception of sound elevation in the right channel. Similarly, virtual height filter 1400 may be optimized for the left channel. For example, the filter transfer function of virtual height filter 1400 may be selected for maximizing perception of sound elevation in the left channel. In general, adapting the virtual height filters for the different channels provides a better perception of sound elevation at the listening positions associated with the respective (in this example, left and right) channels.

Virtual height filtered signal 1175 is mixed with non-height channel 1100 to generate channel signal 1017 to feed loudspeaker 2. Virtual height filtered signal 1200 is mixed with non-height channel 1050 to generate channel signal 1009 to feed loudspeaker 1. An enhanced perception of sound elevation may thus be achieved by playing back channels (signals) 1009 and 1017 with loudspeakers 1 and 2, respectively.

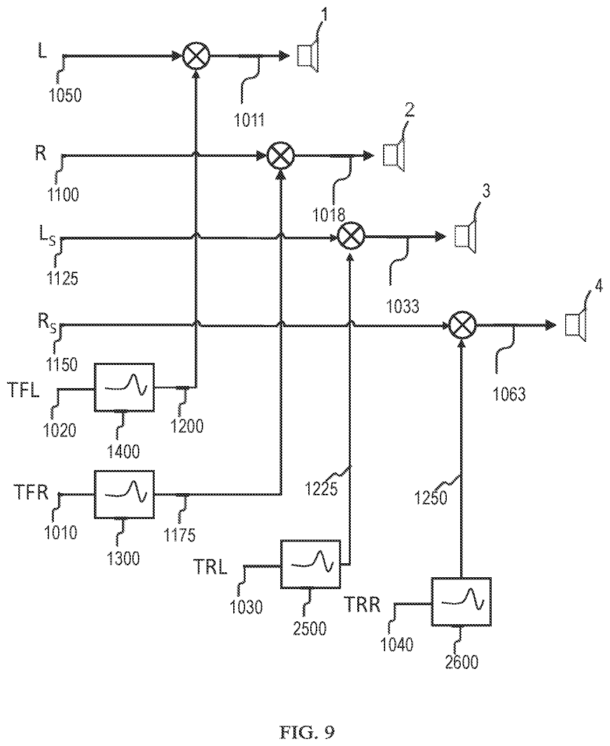

In another example, with reference to FIG. 9, the immersive audio format of the audio comprises four non-height channels 1050, 1100, 1125 and 1150 and four height channels 1010, 1020, 1030 and 1040. Non-height channels 1050 and 1100 may be Left (L) and Right (R) channels, respectively. Non-height channels 1125 and 1150 may be Left surround (Ls) and Right Surround (Rs) channels, respectively. Non-height channels 1050 and 1100 may be Front Left, Middle/Center Left or Rear Left and Right channels, respectively. Similarly, non-height channels 1125 and 1150 may be Front Surround Left, Middle/Center Surround Left or Rear Surround Left and Right Surround channels, respectively. Height channels 1020 and 1010 may be Top Front Left (TFL) and Top Front Right (TFL) channels. Height channels 1040 and 1030 may be Top Rear Right (TRR) and Top Rear Left (TRL) channels. Virtual height filter 1300 is applied to height channel 1010 to generate virtual height filtered signal 1175. Virtual height filter 1400 is applied to height channel 1020 to generate virtual height filtered signal 1200. Virtual height filter 2500 is applied to height channel 1030 to generate virtual height filtered signal 1225. Virtual height filter 2600 is applied to height channel 1040 to generate virtual height filtered signal 1250. Virtual height filters 1300, 1400, 2500, 2600 may be the same or different, as explained with reference to the example of FIG. 8.

Virtual height filtered signal 1175 is mixed with non-height channel 1100 to generate channel signal 1018 to feed loudspeaker 2. Virtual height filtered signal 1200 is mixed with non-height channel 1050 to generate channel signal 1011 to feed loudspeaker 1. Virtual height filtered signal 1225 is mixed with non-height channel 1125 to generate channel signal 1033 to feed loudspeaker 3. Virtual height filtered signal 1250 is mixed with non-height channel 1150 to generate channel signal 1063 to feed loudspeaker 4.

An enhanced perception of sound elevation may thus be achieved by playing back channels (channel signals) 1011, 1018, 1033 and 1063 with loudspeakers 1-4, respectively.

As explained with the Examples of FIGS. 2A, 7-9, the channels used for playback are generally less than the number of channels of the immersive audio format. Therefore, it can be said that the channels of the immersive audio format are downmixed in the channels for playback.

Any other suitable immersive audio format and/or speaker configuration can be envisaged, suitable for the specific implementation.

For example, in addition to the channels of the examples shown with reference to FIGS. 7-9, the audio in the immersive audio format may also include a center (C) channel and/or a Low Frequency Effect (LFE) channel (not shown in any of the FIGS. 7-9). As explained above, since height cues are typically more prevalent in high frequency signals rather than low frequency signals, when present, the center channel and/or the LFE channel are typically not mixed with the filtered height channels.

In some embodiments (not shown in the Figures), when the center channel is present, the center channel may be mixed together with the Front Left and Front Right channels. In such embodiments, mixing of the filtered height channel(s) with the non-height audio channel(s) (i.e. the Front Left and/or the Front Right channels) may be performed after mixing the Front Left and Front Right channels with the Center channel.

Similar considerations are applicable for loudspeaker configurations as shown in FIG. 4, which also include Middle Left (ML) and Middle Right (MR) loudspeakers 4230 and 4240. It is expedient that for any loudspeaker configuration used, all loudspeakers in the system remain active during playback of the generated channels.

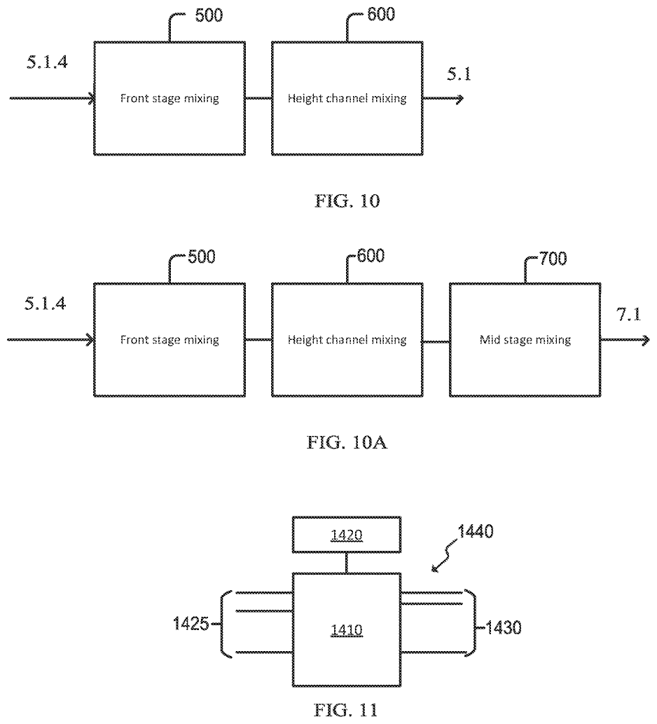

FIG. 10 schematically shows an example of a method of generating six audio channels (i.e. audio in 5.1 audio format) from audio in an immersive audio format according to an embodiment of the disclosure. Output in 5.1 audio format is for example suitable for the loudspeaker system shown in FIG. 1. Input audio format is 5.1.4 for example. In this case, as explained above, front stage mixing 500 may be employed, to, e.g., mix Front Left, Front Right and Center Channel. However, front stage mixing 500 may be enabled or disabled suitably, according to the specific implementation. When front stage mixing 500 is enabled, the filtered four height channels of input audio 5.1.4 may be mixed, in block 600, with four non-height channels as follows. The two non-height Front Left and Front Right channels mixed with the center channel are in turn mixed with the filtered, e.g., TFL and TFR. The two non-height LS and RS are directly mixed with the TRL and TRR. When front stage mixing 500 is disabled, the filtered four height channels may be mixed, in block 600, directly with the input four non-height channels (i.e. without mixing them with the center channel). In this example the center channel signal is not mixed and directly fed to center loudspeaker 10 of FIG. 1. Similarly, in this example, the LFE channel is not mixed and directly fed to LFE loudspeaker 11 of FIG. 1. The channels generated by mixing with the height channels are fed to the corresponding Front and Rear loudspeakers, as explained with reference to the example of FIG. 9.

FIG. 10A schematically shows an example of a method of generating eight audio channels (i.e. audio in 7.1 audio format) from audio in an immersive audio format according to an embodiment of the disclosure. Output in 7.1 audio format is for example suitable for the loudspeaker system shown in FIG. 4.

In this example, to maintain active all loudspeakers of loudspeaker system of FIG. 4, an additional mid stage mixing 700 may be employed, to obtain an audio output in 7.1 audio format.

The process will be the same as explained with reference to FIG. 10 and it is here not repeated. At the output of block 600 the audio output will be in 5.1 audio format as explained with reference to FIG. 10. An additional mid stage mixing block 700 converts the audio from 5.1. to 7.1 audio format to feed all loudspeakers of the loudspeaker system shown in FIG. 4. In practical implementations front stage mixing 500 and mid stage mixing 700 may be always implemented in the vehicle/processor or apparatus and enabled/disabled as required by the specific loudspeaker system configuration and/or front stage mixing requirements.

In some embodiments, the non-height channels, e.g. the Front Left and Front Right channels and/or the Rear Left and Rear Right channels, are processed prior to be mixed with the corresponding virtual filtered height channels. For example, the Front Left and Front Right channels and/or the Rear Left and Rear Right channels, may be processed to compensate for the off-center listening position of the passenger(s)/driver in the vehicle. Compensation of the off-center listening position may be performed with the algorithm described in EP1994795B1, which is hereby incorporated by reference in its entirety. In EP1 994795B1 it was shown that it is possible to ‘virtual center’ two listening positions symmetrically off-center from the same pair of (stereo) loudspeakers at the same time. This follows the same principle of reducing the phase differences of an interaural phase difference (IDP) of a single listening position. In case of two listening positions, the phase differences of the IDP obtained for each of the two listening positions are simultaneously reduced such that each IDP at each listening position has across the desired frequency range values between −90 and 90 degrees. By compensating for the off-center listening positions and mixing the filtered height channels with the corresponding compensated Front and/or Rear non-height channels, panning of the content of the height channels across the Front and/or Rear loudspeakers may be prevented.

### Example Computing Device

A method of generating at least two audio channels from audio in an immersive audio format for playing back the at least two audio channels with a non-immersive loudspeaker system of at least two audio loudspeakers has been described. Additionally, the present disclosure also relates to an apparatus for carrying out these methods. Furthermore, the present disclosure relates to a vehicle which may comprise an apparatus for carrying out these methods. An example of such apparatus 1440 is schematically illustrated in FIG. 11. The apparatus 1440 may comprise a processor 1410 (e.g., a central processing unit (CPU), a graphics processing unit (GPU), a digital signal processor (DSP), one or more application specific integrated circuits (ASICs), one or more radio-frequency integrated circuits (RFICs), or any combination of these) and a memory 1420 coupled to the processor 1410. Memory 1420 may for example store an (or a set of) analytical function(s) or a (or a set of) look up table(s) representing the one or more parameters identifying the filter transfer function of the virtual height filter, e.g. for different listening positions and/or elevations of the roof and/or different vehicles. The processor may be configured to carry out some or all of the steps of the methods described throughout the disclosure, e.g. by retrieving the set of analytical functions and/or LTUs from memory 1420. To carry out the method of generating the at least two audio channel, the apparatus 1440 may receive, as inputs, channels of (e.g. rendered) audio in an immersive audio format, e.g. an height channel and one or more front or surround audio channels 1425. In this case, apparatus 1440 may output two or more channel signals 1430 for playback of the channel signals in a non-immersive loudspeaker system.

The apparatus 1440 may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that apparatus. Further, while only a single apparatus 1440 is illustrated in FIG. 11, the present disclosure shall relate to any collection of apparatus that individually or jointly execute instructions to perform any one or more of the methodologies discussed herein.

The present disclosure further relates to a program (e.g., computer program) comprising instructions that, when executed by a processor, cause the processor to carry out some or all of the steps of the methods described herein.

Yet further, the present disclosure relates to a computer-readable (or machine-readable) storage medium storing the aforementioned program. Here, the term “computer-readable storage medium” includes, but is not limited to, data repositories in the form of solid-state memories, optical media, and magnetic media, for example.

Embodiments described herein may be implemented in hardware, software, firmware and combinations thereof. For example, embodiments may be implemented on a system comprising electronic circuitry and components, such a computer system. Examples of computer systems include desktop computer systems, portable computer systems (e.g. laptops), handheld devices (e.g. smartphones or tablets) and networking devices. Systems for implementing the embodiments may for example comprise at least one of an integrated circuit (IC), a programmable logic device (PLD) such as a field programmable gate array (FPGA), a digital signal processor (DSP), an application specific IC (ASIC), a central processing unit (CPU), and a graphics processing unit (GPU).

Certain implementations of embodiments described herein may comprise a computer program product comprising instructions which, when executed by a data processing system, cause the data processing system to perform a method of any of the embodiments described herein. The computer program product may comprise a non-transitory medium storing said instructions, e.g. physical media such as magnetic data storage media including floppy diskettes and hard disk drives, optical data storage media including CD ROMs and DVDs, and electronic data storage media including ROMs, flash memory such as flash RAM or a USB flash drive. In another example, the computer program product comprises a data stream comprising said instructions, or a file comprising said instructions stored in a distributed computing system, e.g. in one or more data centers.

The present disclosure is not restricted to the embodiments and examples described above. Numerous modifications and variations can be made without departing from the scope of the present disclosure, defined by the accompanying claims.

Various aspects of the present invention may be appreciated from the following enumerated example embodiments (A-EEEs and B-EEEs):
A-EEE1. A method of generating discrete channels from an immersive bitstream, comprising
identifying one or more height channels and one or more non-height channels of the immersive bitstream,
processing the one or more height channels using a virtual height filter and a non-standard mixing technique, and
mixing the processed one or more height channels with the one or more non-height channels.
B-EEE 1. A method (1000) of generating at least two audio channels from audio in an immersive audio format comprising at least one height audio channel (1010) and at least two non-height audio channels (1050, 1100), for playing back the at least two audio channels with a non-immersive loudspeaker system of at least two audio loudspeakers (1,2) inside a vehicle, the method comprising:
   applying (1500) a virtual height filter (1300) to the at least one height channel (1010) for, when the at least one audio height channel is played back by one of the at least two loudspeakers, at least partially attenuating spectral components of the at least one height channel (1010) directly emanating from said loudspeaker (1,2) and for at least partially amplifying spectral components of the at least one height channel reflected from a roof or an area close to the roof inside the vehicle, to generate at least one virtual height filtered audio signal (1175),
   mixing (1700) the at least one virtual height filtered audio signal (1175) with at least one of the two non-height audio channels to generate the at least two audio channels (1008, 1016).
B-EEE 2. The method (1000) of B-EEE 1, wherein the audio in the immersive audio format further comprises at least two further non-height audio channels (1125,1150) and wherein the virtual height filtered audio signal (1175) is mixed with each one of the non-height audio channels (1050, 1100, 1125, 1150) to generate four audio channels (1008, 1016, 1032, 1064).
B-EEE 3. The method of any of the previous B-EEEs, wherein the audio in the immersive audio format comprises at least two height audio channels (1010,1020), and wherein the virtual height filter (1300, 1400) is applied to each one of the at least two height audio channels (1010, 1020) to generate at least two virtual height filtered audio signal (1175, 1200) and wherein each one of the virtual height filtered audio signals (1175, 1200) is mixed with one of the at least two non-height channels (1100, 1050).
B-EEE 4. The method of any one of the previous B-EEEs, wherein the audio in the immersive audio format comprises four height audio channels (1010,1020, 1030, 1040) and four non-height audio channels (1050, 1100, 1125, 1150), and wherein the virtual height filter (1300, 1400, 2500, 2600) is applied to each one of the four height audio channels (1010, 1020, 1030, 1040) to generate four virtual height filtered audio signals (1175, 1200, 1225, 1250) and wherein each one of the virtual height filtered audio signals (1175, 1200, 1225, 1250) is mixed with one of the four non-height channels (1100, 1050, 1125, 1150).
B-EEE 5. The method of any one of the previous B-EEEs, wherein the non-immersive loudspeaker system is a stereo or surround loudspeaker system.
B-EEE 6. The method of any one of the previous B-EEEs, wherein the virtual height filter has a filter transfer function and wherein the method further comprises determining the filter transfer function of the virtual height filter from one or more parameters identifying the filter transfer function.
B-EEE 7. The method of any one of the previous B-EEEs, wherein the virtual height filter has a filter transfer function having a peak at a first frequency and a notch at a second frequency higher than the first frequency.
B-EEE 8. The method of B-EEEs 6 and 7, wherein the one or more parameters are indicative of at least one value of: a peak, a first frequency, a notch, and a second frequency of the filter transfer function.
B-EEE 9. The method of any one of the previous B-EEEs, wherein the at least two audio loudspeakers (1,2) are laterally spaced with respect to a listening position.
B-EEE 10. The method of B-EEE 9, further comprising determining (1800) a filter transfer function for the virtual height filter based on a relative distance of the at the least two loudspeakers from the listening position and on an elevation of the roof or area close to the roof relative to the listening position.
B-EEE 11. The method of B-EEE 9, further comprising
   obtaining (1900) a plurality of filter transfer functions for a plurality of virtual height filters based on a range of relative distances of the at the least two loudspeakers from the listening position and on a range of elevations of the roof or area close to the roof relative to the listening position and
   selecting (2000) one filter transfer function from the plurality of filter transfer functions.
B-EEE 12. The method of claim 11, wherein the selected filter transfer function is the average of the plurality of filter transfer functions.
B-EEE 13. The method of claim 11 as far dependent on any of the claim 6 to 8, wherein selecting one filter transfer function from the plurality of filter transfer functions comprises selecting one or more parameters identifying the selected filter transfer function based on an average distance of the at the least two loudspeakers from the listening position and based on an average elevation of the roof or area close to the roof relative to the listening position.
B-EEE 14. The method of any of the B-EEEs 11 to 13, wherein the steps obtaining (1900), selecting (2000), applying (1500) and mixing (1700) are iteratively applied for each selected filter transfer function until the filter transfer function provides a playback of the at least two channels with maximum perception of sound elevation.
B-EEE 15. The method of any one of the B-EEEs 6 to 14, further comprising storing the one or more parameters in a processor as a look-up table or as an analytical function.
B-EEE 16. The method of any one of the preceding B-EEEs, further comprising applying a gain to the virtual height filter.
B-EEE 17. The method of B-EEE 16, wherein the gain is user configurable.
B-EEE 18. The method of any one of the previous B-EEEs, wherein the audio in the immersive audio format is audio rendered in the immersive audio format and/or wherein the immersive audio format is Dolby Atmos, or any X.Y.Z audio format where X≥2 is the number of front or surround audio channels, Y≥0 is, when present, a Low Frequency Effects or subwoofer audio channel, and Z≥1 is the at least one height audio channel.
B-EEE 19. An apparatus configured to perform the method of any of B-EEEs 1-18.
B-EEE 20. A vehicle including a loudspeaker system of at least two audio loudspeakers (1,2), further comprising the apparatus of B-EEE 19.
B-EEE 21. A program comprising instructions that, when executed by a processor, cause the processor to carry out the method according to any one of the B-EEEs 1-18.
B-EEE 22. A computer-readable storage medium storing the program according to B-EEE 21.

1. A method of generating at least two audio channels from audio in an immersive audio format comprising at least one height audio channel and at least two non-height audio channels, for playing back the at least two audio channels with a non-immersive loudspeaker system of at least two audio loudspeakers inside a vehicle, the method comprising:
applying a virtual height filter to the at least one height channel for, when the at least one audio height channel is played back by one of the at least two loudspeakers, at least partially attenuating spectral components of the at least one height channel directly emanating from said loudspeaker and for at least partially amplifying spectral components of the at least one height channel reflected from a roof or an area close to the roof inside the vehicle, to generate at least one virtual height filtered audio signal; and
mixing the at least one virtual height filtered audio signal with at least one of the two non-height audio channels to generate the at least two audio channels.

2. The method of claim 1, wherein the audio in an immersive audio format further comprises at least two further non-height audio channels and wherein the virtual height filtered audio signal is mixed with each one of the non-height audio channels to generate four audio channels.

3. The method of claim 1, wherein the audio in an immersive audio format comprises at least two height audio channels, and wherein the virtual height filter is applied to each one of the at least two height audio channels to generate at least two virtual height filtered audio signal and wherein each one of the virtual height filtered audio signals is mixed with one of the at least two non-height channels.

4. The method of claim 1, wherein the audio in an immersive audio format comprises four height audio channels and four non-height audio channels, and wherein the virtual height filter is applied to each one of the four height audio channels to generate four virtual height filtered audio signals and wherein each one of the virtual height filtered audio signals is mixed with one of the four non-height channels.

5. The method of claim 1, wherein the non-immersive loudspeaker system is a stereo or surround loudspeaker system.

6. The method of claim 1, wherein the virtual height filter has a filter transfer function and wherein the method further comprises determining the filter transfer function of the virtual height filter from one or more parameters identifying the filter transfer function.

7. The method of claim 1, wherein the virtual height filter has a filter transfer function having a peak at a first frequency and a notch at a second frequency higher than the first frequency.

8. The method of claim 6, wherein the one or more parameters are indicative of at least one value of: a peak, a first frequency, a notch, and a second frequency of the filter transfer function.

9. The method of claim 1, wherein the at least two audio loudspeakers are laterally spaced with respect to a listening position.

10. The method of claim 9, further comprising determining a filter transfer function for the virtual height filter based on a relative distance of the at the least two loudspeakers from the listening position and on an elevation of the roof or area close to the roof relative to the listening position.

11. The method of claim 9, further comprising
obtaining a plurality of filter transfer functions for a plurality of virtual height filters based on a range of relative distances of the at the least two loudspeakers from the listening position and on a range of elevations of the roof or area close to the roof relative to the listening position; and
selecting one filter transfer function from the plurality of filter transfer functions.

12. The method of claim 11, wherein the selected filter transfer function is the average of the plurality of filter transfer functions.

13. The method of claim 6, wherein determining the filter transfer function includes selecting one filter transfer function from a plurality of filter transfer functions includes selecting one or more parameters identifying the selected filter transfer function based on an average distance of the at the least two loudspeakers from the listening position and based on an average elevation of the roof or area close to the roof relative to the listening position.

14. The method of claim 11, wherein the steps of obtaining, selecting, applying and mixing are iteratively applied for each selected filter transfer function until the filter transfer function provides a playback of the at least two channels with maximum perception of sound elevation.

15. The method of claim 6, further comprising storing the one or more parameters in a processor as a look-up table or as an analytical function.

16. The method of claim 1, further comprising applying a gain or a user-configurable gain to the virtual height filter.

17. The method of claim 1, wherein the audio in an immersive audio format is audio rendered in the immersive audio format and/or wherein the immersive audio format is Dolby Atmos, or any X.Y.Z audio format where X>2 is the number of front or surround audio channels, Y≥0 is, when present, a Low Frequency Effects or subwoofer audio channel, and Z≥1 is the at least one height audio channel.

18. An apparatus comprising a processor and a memory storing one or more programs including instructions for performing the method of claim 1.

19. The apparatus of claim 18, wherein the apparatus is a vehicle including a loudspeaker system of at least two audio loudspeakers.

20. A non-transitory computer-readable storage medium storing one or more programs including instructions that, when executed by a processor, cause the processor to carry out the method according to claim 1.

21. (canceled)
